(19) United States
(12) Patent Application Publication
(10) Pub. No.: US 2025/0365788 A1
(43) Pub. Date: Nov. 27, 2025

(54) SYSTEMS AND METHODS FOR PROVIDING MULTIMEDIA PRIORITY SERVICE BETWEEN A CORE NETWORK AND ANOTHER NETWORK

(71) Applicant: Verizon Patent and Licensing Inc., Basking Ridge, NJ (US)

(72) Inventors: Chien-Yuan Huang, Basking Ridge, NJ (US); Toby Varughese John, Murphy, TX (US); John Cao Vinh Nguyen, Trophy Club, TX (US); Glenda T. Baloto, San Ramon, CA (US)

(21) Appl. No.: 18/674,258

(22) Filed: May 24, 2024

(51) Int. Cl. H04W 76/12; H04L 12/06; H04W 84/12

(52) U.S. Cl. CPC H04W 76/12; H04W 84/12

(57) ABSTRACT

A device may include a processor configured to receive a request to establish a Multimedia Priority Service (MPS) session for a user equipment (UE) device. The processor may be further configured to generate a General Packet Radio Service (GPRS) Tunnelling Protocol (GTP) tunnel in a core network from the device to a gateway associated with a packet data network (PDN); map an MPS priority to data units associated with the MPS session sent via the generated GTP tunnel; generate an Internet Protocol Security (IPSec) tunnel from the device to the UE device through a wireless local area network (WLAN); and prioritize data units associated with the MPS session through the IPSec tunnel based on the MPS priority.

### BACKGROUND INFORMATION

To satisfy the needs and demands of users of mobile communication devices, providers of wireless communication services continue to improve and expand available services as well as networks used to deliver such services. One aspect of such improvements includes enabling mobile communication devices to access and use various services via the provider's communication network across different types of devices or access points. Managing a wireless communication service over time across different devices or access points may pose various difficulties.

### BRIEF DESCRIPTION OF THE DRAWINGS

FIG. 1 illustrates an environment according to an implementation described herein;

FIG. 2 illustrates exemplary components of a Fourth Generation (4G) core network according to an implementation described herein;

FIG. 3 illustrates exemplary components of a Fifth Generation (5G) core network according to an implementation described herein;

FIG. 4 illustrates exemplary components of a device that may be included in an environment according to an implementation described herein;

FIG. 5 illustrates exemplary components of a wireless local area network (WLAN) interface device according to an implementation described herein;

FIG. 6 illustrates exemplary components of a multimedia priority service (MPS) sessions database (DB) according to an implementation described herein;

FIG. 7 illustrates a flowchart of a process for providing MPS according to an implementation described herein;

FIG. 8 illustrates a first exemplary signal flow diagram according to an implementation described herein; and

FIG. 9 illustrates a second exemplary signal flow diagram according to an implementation described herein.

### DETAILED DESCRIPTION OF PREFERRED EMBODIMENTS

The following detailed description refers to the accompanying drawings. The same reference numbers in different drawings identify the same or similar elements.

Providers of wireless communication services operate radio access networks (RANs) that include base stations. The base stations enable wireless communication devices (e.g., smart phones, etc.), referred to as user equipment (UE) devices (also herein referred to as UEs), to connect to networks and obtain services via the provider's core network, such as a Fourth Generation (4G) core network, a Fifth Generation (5G) core network, and/or other next generation networks as defined by the 3^{rd} Generation Partnership Project (3GPP). 5G coverage may be provided using 5G base stations, referred to as gNodeBs, implementing the 5G New Radio (NR) air interface.

An important service that a provider may implement on a RAN and an associated core network is Multimedia Priority Service (MPS). MPS may provide priority access to cellular wireless communication services for users authorized and/or required to maintain wireless communication capabilities during accidents, natural disasters, and/or other situations where public safety and/or security may be at risk. Such users may include, for example, emergency medical services (EMS) personnel, firemen, police, military personnel, search and rescue personnel, government employees coordinating disaster relief efforts, etc. A provider of cellular wireless communication services may reserve network resources for MPS communication sessions.

A user authorized for MPS may request an MPS session via an authorized UE device with an MPS application/service enabled on the UE device. An MPS session may include a video, voice, data session and/or another type of communication session. When a UE device requests an MPS session, the core network may authenticate and authorize the UE device for the MPS session and may establish a session from the UE device via the RAN and the core network to a packet data network (PDN) via a gateway.

However, in many situations, a UE device may connect to the core network not via a RAN but via another network. The other network may include a non-trusted (e.g., a non-3GPP) network, such as a wireless local area network (WLAN). For example, the UE device may connect to a WI-FI network via a WI-FI access point (AP) and connect to the core network via the WI-FI network. A WI-FI network may not be configured to enable MPS sessions from the UE device to the core network.

Implementations described herein relate to systems and methods to provide MPS between a core network and another network, such as a WI-FI network and/or another type of WLAN network. A WLAN interface device may be configured to enable UE devices to connect to a cellular wireless core network via a WLAN network, such as, for example, a WI-FI network and be further configured to establish an MPS session between a UE device and a core network via the WI-FI network. In some implementations, the WLAN interface device may include an evolved Packet Data Gateway (ePDG). In other implementations, the WLAN interface device may include a Non-Third-Generation-Partnership-Project Interworking Function (N3IWF).

The WLAN interface device may be configured to receive a request to establish an MPS session for a UE device; authenticate the UE device to determine that the UE device is authorized to establish the MPS session; generate a General Packet Radio Service (GPRS) Tunnelling Protocol (GTP) tunnel in a core network from the WLAN interface device to a gateway associated with a packet data network (PDN); map an MPS priority to data units associated with the MPS session sent via the generated GTP tunnel; generate an Internet Protocol Security (IPSec) tunnel from the device to the UE device through a WLAN; and prioritize data units associated with the MPS session through the IPSec tunnel based on the MPS priority. In some implementations, the WLAN interface device may be further configured to instruct a WI-FI AP associated with the MPS session for the UE device to process data units associated with the MPS session based on the MPS priority.

Furthermore, the WLAN interface device may be configured to determine whether a load for a resource parameter associated with the WLAN interface device is greater than a resource load threshold. The resource parameter may include, for example, a number of UE device connections associated with the WLAN interface device, a traffic load for one or more GTP tunnels associated with the WLAN interface device, a traffic load for one or more IPSec tunnels associated with the WLAN interface device, a processor load associated with the WLAN interface device, a memory load associated with the WLAN interface device, a port load associated with the WLAN interface device, and/or another resource parameter associated with the WLAN interface device.

If the WLAN interface device determines that the load for the resource parameter associated with the WLAN interface device is greater than the resource load threshold, the WLAN interface device may detect that the WLAN interface device is in a congested state. In response to detecting the congested state, the WLAN interface device may generate a dedicated IPSec tunnel for the MPS session, reserve resources associated with the resource parameter for the dedicated IPSec tunnel, and use the generated dedicated IPSec tunnel for MPS data units associated with MPS session.

Additionally, or alternatively, in response to detecting the congested state, the WLAN interface device may generate a dedicated GTP tunnel to the gateway for MPS data units, reserve resources associated with the resource parameter for the dedicated GTP tunnel, and use the generated dedicated GTP tunnel to the gateway for MPS data units associated with MPS session.

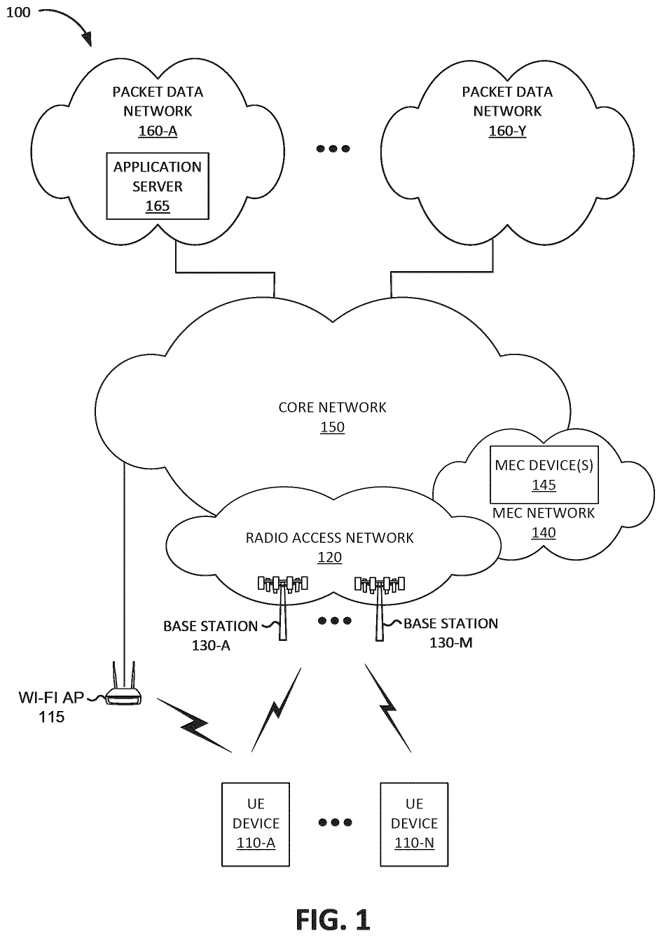

FIG. 1 is a diagram of an exemplary environment 100 in which the systems and/or methods described herein may be implemented. As shown in FIG. 1, environment 100 may include UE devices 110-A to 110-N (referred to herein collectively as “UE devices 110” and individually as “UE device 110”), a WI-FI AP 115, a RAN 120 that includes base stations 130-A to 130-M (referred to herein collectively as “base stations 130” and individually as “base station 130”), a Multi-Access Edge Computing (MEC) network 140, a core network 150, and packet data networks (PDNs) 160-A to 160-Y (referred to herein collectively as “PDNs 160” and individually as “PDN 160”).

UE device 110 may include any mobile device with cellular wireless communication functionality and with WLAN communication functionality, such as WI-FI communication functionality. UE device 110 may include a handheld wireless communication device (e.g., a mobile phone, a smart phone, a tablet device, etc.); a wearable computer device (e.g., a head-mounted display computer device, a wristwatch computer device, etc.); a laptop computer, a tablet computer, a portable gaming system, and/or another type of portable computer; a Fixed Wireless Access (FWA) device; and/or any other type of mobile computer device with cellular wireless communication capabilities. In some implementations, UE device 110 may communicate using machine-to-machine (M2M) communication, such as Machine Type Communication (MTC), and/or another type of M2M communication for IoT applications.

WI-FI AP 115 may include a device with a transceiver configured to communicate with UE device 110 using WiFi signals based on the Institute of Electrical and Electronics Engineers (IEEE) 802.11 standards for implementing a wireless LAN (WLAN) network. WI-FI AP 115 may enable UE device 110 to communicate with other devices in a WI-FI WLAN network (not shown in FIG. 1) and with core network 150 via a wired/wireless connection and a WLAN interface device (not shown in FIG. 1).

RAN 120 may include base stations 130 and be managed by a provider of wireless communication services. RAN 120 may enable UE devices 110 to connect to core network 150 via base stations 130 using cellular wireless signals. For example, RAN 120 may include one or more central units (CUs), distributed units (DUs), and/or Radio Units (RUs) (not shown in FIG. 1) that enable and manage connections from RUs to core network 150. RAN 120 may include features associated with an LTE Advanced (LTE-A) network and/or a 5G network or other advanced network, such as features for or associated with management of 5G NR base stations; carrier aggregation; advanced or massive MIMO configurations (e.g., an 8×8 antenna configuration, a 16×16 antenna configuration, a 256×256 antenna configuration, etc.); cooperative MIMO (CO-MIMO); relay stations; Heterogeneous Networks (HetNets) of overlapping small cells and macrocells; Self-Organizing Network (SON) functionality; MTC functionality, such as 1.4 Megahertz (MHz) wide enhanced MTC (eMTC) channels (also referred to as category Cat-M1), Low Power Wide Area (LPWA) technology such as Narrow Band (NB) IoT (NB-IoT) technology, and/or other types of MTC technology; and/or other types of LTE-A and/or 5G functionality.

Base station 130 may include a 5G NR base station (e.g., a gNodeB) and/or a 4G Long Term Evolution (LTE) base station (e.g., an eNodeB). Base stations 130 may include devices and/or components configured to enable cellular wireless communication with UE devices 110. For example, base stations 130 may include a radio frequency (RF) transceiver configured to communicate with UE devices 110 using a 5G NR air interface using a 5G NR protocol stack, a 4G LTE air interface using a 4G LTE protocol stack, and/or using another type of cellular air interface.

MEC network 140 may be associated with RAN 120 and may provide MEC services for UE devices 110 attached to base stations 130. MEC network 140 may be in proximity to base stations 130 from a geographic and network topology perspective, thus enabling low latency services to be provided to UE devices 110. As an example, MEC network 140 may be located on the same site as base station 130. As another example, MEC network 140 may be geographically closer to one of base stations 130 and reachable via fewer network hops and/or fewer switches, than other macro cell base stations 130.

MEC network 140 may include one or more MEC devices 145. MEC devices 145 may provide MEC services to UE devices 110. A MEC service may include, for example, a low-latency microservice associated with a particular application, a microservice associated with a virtualized network function (VNF) of core network 150, a cloud computing service, such as cache storage service, artificial intelligence (AI) accelerator service, machine learning service, an image processing service, a data compression service, a locally centralized gaming service, a Graphics Processing Units (GPUs) and/or other types of hardware accelerator service, and/or other types of cloud computing services.

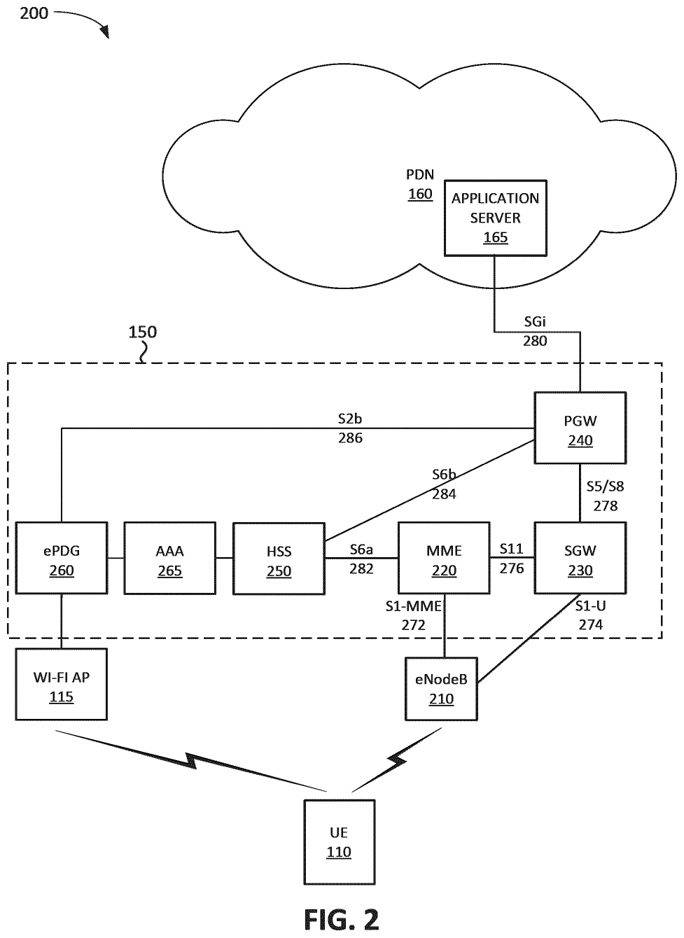

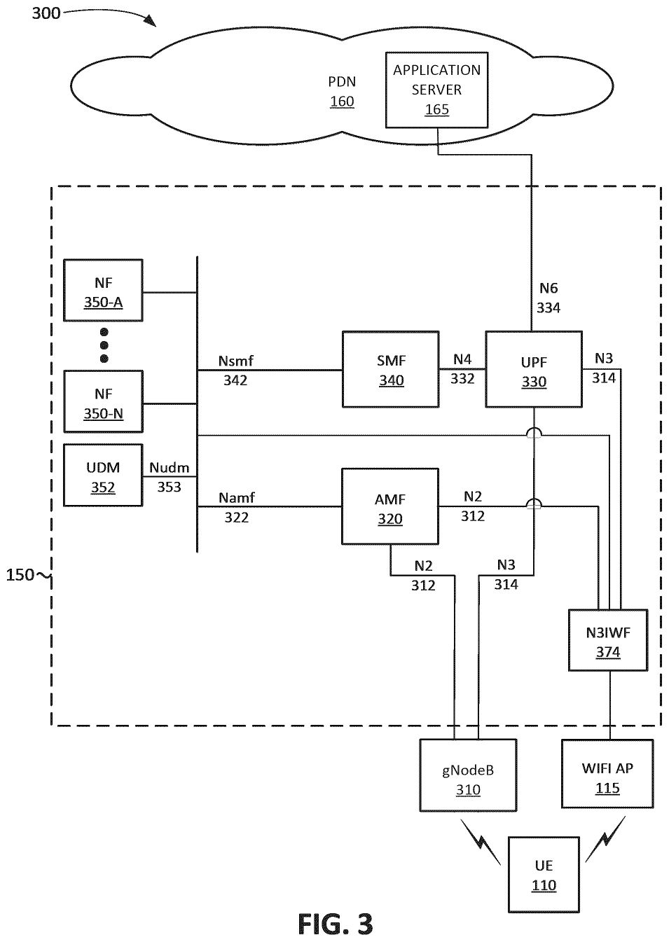

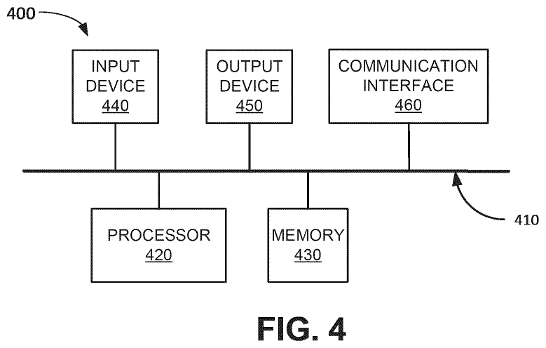

Core network 150 may be managed by the provider of cellular wireless communication services and may manage communication sessions of subscribers connecting to core network 150 via RAN 120 and/or another network (e.g., a WLAN). For example, core network 150 may establish an Internet Protocol (IP) connection between UE devices 110 and PDN 160. The components of core network 150 may be implemented as dedicated hardware components and/or as Virtual Network Functions (VNFs) implemented on top of a common shared physical infrastructure using Software Defined Networking (SDN). For example, an SDN controller may implement one or more of the components of core network 150 using an adapter implementing a VNF virtual machine, a Cloud-Native Network Function (CNF) container, an event driven serverless architecture, and/or another type of SDN architecture. The common shared physical infrastructure may be implemented using one or more devices 400 described below with reference to FIG. 4 in a cloud computing center associated with core network 150. Additionally, or alternatively, at least some of the components of core network 150 may be implemented using MEC devices 145 in MEC network 140. In some implementations, core network 150 may include a 4G core network. Exemplary components that may be included in core network 150 are described below with reference to FIG. 2. In other implementations, core network 150 may include a 5G core network. Exemplary components that may be included in core network 150 are described below with reference to FIG. 3.

PDNs 160-A to 160-Y may each be associated with a Data Network Name (DNN) in 5G, and/or an Access Point Name (APN) in 4G. UE device 110 may request a connection to PDN 160 using a DNN or an APN. For example, UE device 110 may request a data flow connection to an application server 165 (shown in PDN 160-A). PDN 160 may include, and/or be connected to, a local area network (LAN), a wide area network (WAN), a metropolitan area network (MAN), an autonomous system (AS) on the Internet, an optical network, a cable television network, a satellite network, a wireless network, an ad hoc network, a telephone network (e.g., the Public Switched Telephone Network (PSTN) or a cellular network), an intranet, or a combination of networks. PDN 160 may include application server 165. Application server 165 may include one or more computer devices that host one or more applications and/or other types of services used by UE device 110. Core network 150 may establish a data flow session between UE device 110 and application server 165 via RAN 120 and/or a WLAN.

Although FIG. 1 shows exemplary components of environment 100, in other implementations, environment 100 may include fewer components, different components, differently arranged components, or additional components than depicted in FIG. 1. Additionally, or alternatively, one or more components of environment 100 may perform functions described as being performed by one or more other components of environment 100.

FIG. 2 is a diagram illustrating exemplary components of an environment 200 that includes UE device 110, WI-FI AP 115, eNodeB 210, core network 150, and PDN 160. In environment 200, core network 150 includes a 4G core network, also referred to as an Evolved Packet Core (EPC) network.

eNodeB 210 may correspond to a 4G base station 130 in RAN 120. Core network 150 may include a mobility management entity (MME) 220, a serving gateway (SGW) 230, a PGW 240, a home subscriber server (HSS) 250, an ePDG 260, and an Authentication, Authorization and Accounting server (AAA) 265. While FIG. 2 depicts a single eNodeB 210, MME 220, SGW 230, PGW 240, HSS 250, ePDG 260, and AAA 265 for illustration purposes, in practice, FIG. 2 may include multiple eNodeBs 210, MMEs 220, SGWs 230, PGWs 240, HSS 250, ePDGs 260, and/or AAAs 265.

eNodeB 210 may interface with core network 150 via an interface referred to as an S1 interface, which may be split into a control plane S1-MME interface 262 and a data plane S1-U interface 264. S1-MME interface 262 may interface with MME 220. S1-MME interface 272 may be implemented, for example, with a protocol stack that includes a Network Access Server (NAS) protocol and/or Stream Control Transmission Protocol (SCTP). An S1-U interface 274 may interface with SGW 230 and may be implemented, for example, using GTP version 2 (GTPv2).

MME 220 may implement control plane processing for core network 150. For example, MME 220 may implement tracking and paging procedures for UE device 110, may activate and deactivate bearers for UE device 110, may authenticate a user of UE device 110, and may interface to non-LTE radio access networks. A bearer may represent a logical channel with particular quality of service (QOS) requirements. MME 220 may also select a particular SGW 230 for a particular UE device 110.

SGW 230 may provide an access point to and from UE device 110, may handle forwarding of data packets for UE device 110, and may act as a local anchor point during handover procedures between eNodeBs 210. SGW 230 may interface with PGW 240 through an S5/S8 interface 278. S5/S8 interface 278 may be implemented, for example, using GTPv2.

PGW 240 may function as a gateway to PDN 160 through an SGi interface 290. A particular UE device 110, while connected to a single SGW 230, may be connected to multiple PGWs 240, one for each packet network with which UE device 110 communicates. For example, a particular PGW 240 may be associated with a particular APN and UE device 110 may connect to the particular APN by connecting to the PGW 240 associated with the particular APN. Thus, UE device 110 may be connected to one or more APNs at a particular time.

MME 220 may communicate with SGW 230 through an S11 interface 276. S11 interface 276 may be implemented, for example, using GTPv2. S11 interface 276 may be used to create and manage a new session for a particular UE device 110. S11 interface 276 may be activated when MME 220 needs to communicate with SGW 230, such as when the particular UE device 110 attaches to core network 150, when bearers need to be added or modified for an existing session for the particular UE device 110, when a connection to a new PGW 240 needs to be created, or during a handover procedure (e.g., when the particular UE device 110 needs to switch to a different SGW 230 and/or ePDG 260).

HSS 250 may store information associated with UE devices 110 and/or information associated with users of UE devices 110. For example, HSS 250 may store subscription profiles that include authentication and access authorization information. Each subscription profile may include a list of UE devices 110 associated with the subscription as well as an indication of which UE device 110 is active (e. g., authorized to connect to core network 150). Additionally, HSS 250 may store information relating to MPS authorization associated with UE device 110, indicating whether UE device 110 is authorized for MPS. MME 220 may communicate with HSS 250 through an S6a interface 282. S6a interface 282 may be implemented, for example, using a Diameter protocol. PGW 240 may communicate with HSS 250 through an S6b interface 284. S6b interface 284 may be implemented, for example, using a Diameter protocol.

ePDG 260 may interface core network 150 with untrusted networks, such as a WI-FI network associated with WI-FI AP 115. ePDG 260 may establish a connection between WiFi AP 115 and PGW 240 after WI-FI AP 115, and/or UE device 110 connecting to ePDG 260 via WI-FI AP 115, has been authenticated and authorized. ePDG 260 may implement MPS between UE device 110 and core network 150 via WI-FI AP 115 as described herein. ePDG 260 may communicate with PGW 240 through an S2b interface 286. S2b interface 286 may be implemented, for example, using GTPv2. ePDG 260 may authorize and authenticate UE device 110 with HSS 250 via AAA 265 to ensure UE device 110 is authorized for MPS. AAA 265 may perform authentication, authorization, and accounting functions for an untrusted device connecting to core network 150. For example, AAA 265 may communicate with HSS 250 via a Diameter protocol to perform authentication and/or authorization of UE device 110.

Although FIG. 2 shows exemplary components of core network 150, in other implementations, core network 150 may include fewer components, different components, differently arranged components, or additional components than depicted in FIG. 2. Additionally or alternatively, one or more components of core network 150 may perform functions described as being performed by one or more other components of core network 150. For example, in some implementations, ePDG 260 may connect to a 5G core network, as described in FIG. 3 below, instead of a 4G core network.

FIG. 3 is a diagram illustrating exemplary components of an environment 300 that includes UE device 110, WI-FI AP 115, gNodeB 310, core network 150, and PDN 160. In environment 300, core network 150 includes a 5G core network. gNodeB 310 may be implemented by base station 130. Core network 150 may include an Access and Mobility Management Function (AF) 320, a User Plane Function (UPF) 330, a Session Management Function (SMF) 340, network functions (NF) 350-A to 350-N, a Unified Data Management (UDM) 352, and an N3IWF 374. While FIG. 3 depicts a single AMF 320, UPF 330, SMF 340, AF 350, UDM 352, and N3IWF for illustration purposes, in practice, core network 150 may include multiple AMFs 320, UPFs 330, SMFs 340, AFs 350, UDMs 352, and/or N3IWFs 374.

AMF 320 may perform registration management, connection management, reachability management, mobility management, lawful intercepts, session management messages transport between UE device 110 and SMF 340, access authentication and authorization, location services management, support non-3GPP access networks, and/or other types of management processes. AMF 320 may be accessible by other function nodes via an Namf interface 322. AMF 320 may communicate with gNodeB 310 via an N2 interface 312.

UPF 330 may maintain an anchor point for intra/inter-Radio Access Technology (RAT) mobility, maintain an external PDU point of interconnect to a particular PDN 160, perform packet routing and forwarding, perform the user plane part of policy rule enforcement, perform packet inspection, perform lawful intercept, perform traffic usage reporting, perform Quality of Service (QoS) handling in the user plane, perform uplink traffic verification, perform transport level packet marking, perform downlink packet buffering, forward an “end marker” to a RAN node (e.g., gNodeB 310), and/or perform other types of user plane processes. UPF 330 may communicate with gNodeB 310 using an N3 interface 314, communicate with SMF 340 using an N4 interface 332, and connect to PDN 160 using an N6 interface 334.

SMF 340 may perform session establishment, session modification, and/or session release, apply policies to data flows, perform IP address allocation and management, perform Dynamic Host Configuration Protocol (DHCP) functions, perform selection and control of UPF 330, configure traffic steering at UPF 330 to guide the traffic to the correct destinations, perform lawful intercepts, charge data collection, support charging interfaces, control and coordinate charging data collection, terminate session management parts of Non-Access Stratum messages, perform downlink data notification, manage roaming functionality, and/or perform other types of control plane processes for managing user plane data. SMF 340 may be accessible via an Nsmf interface 342.

NFs 350-A to 350-N may include other NFs performing particular functions in core network 150, such as, for example, an application function (AF) to provide services associated with a particular application that corresponds to, or interfaces with, application server 165; a Policy Charging Function (PCF) to support policies to control network behavior and provide policy rules to control plane functions (e.g., to SMF 340) and/or access and mobility functions (e.g., to AMF 320) and provide a UE device Route Selection Policy (URSP) to UE device 110; a Charing Function (CHF) to perform charging and/or billing functions for core network 150; a Network Repository Function (NRF) to support a service discovery function and maintain profiles of available network function (NF) instances and their supported services; a Network Exposure Function (NEF) to expose services, capabilities, and/or events to other NFs, including third party NFs, edge computing NFs, and/or other types of NFs, and to secure provisioning of information from external applications to core network 150; a Network Slice Selection Function (NSSF) to select a set of network slice instances to serve a particular UE device 110, determine network slice selection assistance information (NSSAI), determine a particular AMF 320 to serve a particular UE device 110, and/or perform other types of processing associated with network slice selection or management; a Network Data Analytics Function (NWDAF) to collect analytics information associated with RAN 120 and/or core network 150; and/or other types of NFs.

UDM 352 may maintain subscription information for UE devices 110, manage subscriptions, generate authentication credentials, handle user identification, perform access authorization based on subscription data, maintain service and/or session continuity by maintaining assignment of SMF 340 for ongoing sessions, support lawful intercept functionality, and/or perform other processes associated with managing user data. UDM 352 may interface with a Unified Data Repository (UDR) that stores, in a subscription profile associated with a particular UE device 110, a list of network slices which the particular UE device 110 is allowed to access. UDM 352 may be accessible via a Nudm interface 353.

N3IWF 374 may interface core network 150 with untrusted networks, such as a WI-FI network associated with WI-FI AP 115. N3IWF 374 may establish a connection between WiFi AP 115 and UPF 330 after WI-FI AP 115, and/or UE device 110 connecting to N3IWF 374 via WI-FI AP 115, has been authenticated and authorized. N3IWF 374 may implement MPS between UE device 110 and core network 150. N3IWF 374 may communicate with UPF 330 through an N3 interface 314. N3 interface 314 may be implemented, for example, using GTPv2. N3IWF 374 may authorize and authenticate UE device 110 for MPS with UDM 352.

Although FIG. 3 shows exemplary components of core network 150, in other implementations, core network 150 may include fewer components, different components, differently arranged components, or additional components than depicted in FIG. 3. Additionally, or alternatively, one or more components of core network 150 may perform functions described as being performed by one or more other components of core network 150.

FIG. 4 is a diagram illustrating example components of a device 400 according to an implementation described herein. The components of FIG. 1, FIG. 2, and/or FIG. 3 may each include one or more devices 400. As shown in FIG. 4, device 400 may include a bus 410, a processor 420, a memory 430, an input device 440, an output device 450, and a communication interface 460.

Bus 410 may include a path that permits communication among the components of device 400. Processor 420 may include any type of single-core processor, multi-core processor, microprocessor, latch-based processor, central processing unit (CPU), graphics processing unit (GPU), tensor processing unit (TPU), hardware accelerator, and/or processing logic (or families of processors, microprocessors, and/or processing logics) that interprets and executes instructions. In other embodiments, processor 420 may include an application-specific integrated circuit (ASIC), a field-programmable gate array (FPGA), and/or another type of integrated circuit or processing logic.

Memory 430 may include any type of dynamic storage device that may store information and/or instructions, for execution by processor 420, and/or any type of non-volatile storage device that may store information for use by processor 420. For example, memory 430 may include a random access memory (RAM) or another type of dynamic storage device, a read-only memory (ROM) device or another type of static storage device, a content addressable memory (CAM), a magnetic and/or optical recording memory device and its corresponding drive (e.g., a hard disk drive, optical drive, etc.), and/or a removable form of memory, such as a flash memory.

Input device 440 may allow an operator to input information into device 400. Input device 440 may include, for example, a keyboard, a mouse, a pen, a microphone, a remote control, an audio capture device, an image and/or video capture device, a touch-screen display, and/or another type of input device. In some implementations, device 400 may be managed remotely and may not include input device 440. In other words, device 400 may be “headless” and may not include a keyboard, for example.

Output device 450 may output information to an operator of device 400. Output device 450 may include a display, a printer, a speaker, and/or another type of output device. For example, device 400 may include a display, which may include a liquid-crystal display (LCD) for displaying content to the user. In some implementations, device 400 may be managed remotely and may not include output device 450. In other words, device 400 may be “headless” and may not include a display, for example.

Communication interface 460 may include a transceiver that enables device 400 to communicate with other devices and/or systems via wireless communications (e.g., radio frequency, infrared, and/or visual optics, etc.), wired communications (e.g., conductive wire, twisted pair cable, coaxial cable, transmission line, fiber optic cable, and/or waveguide, etc.), or a combination of wireless and wired communications. Communication interface 460 may include a transmitter that converts baseband signals to RF signals and/or a receiver that converts RF signals to baseband signals. Communication interface 460 may be coupled to an antenna for transmitting and receiving RF signals.

Communication interface 460 may include a logical component that includes input and/or output ports, input and/or output systems, and/or other input and output components that facilitate the transmission of data to other devices. For example, communication interface 460 may include a network interface card (e.g., Ethernet card) for wired communications and/or a wireless network interface (e.g., a WiFi) card for wireless communications. Communication interface 460 may also include a universal serial bus (USB) port for communications over a cable, a Bluetooth™ wireless interface, a radio-frequency identification (RFID) interface, a near-field communications (NFC) wireless interface, and/or any other type of interface that converts data from one form to another form.

As will be described in detail below, device 400 may perform certain operations relating to management of MPS between UE device 110 and core network 150 when UE device 110 connects to core network 150 via another network or device different from RAN 120. Device 400 may perform these operations in response to processor 420 executing software instructions contained in a computer-readable medium, such as memory 430. A computer-readable medium may be defined as a non-transitory memory device. A memory device may be implemented within a single physical memory device or spread across multiple physical memory devices. The software instructions may be read into memory 430 from another computer-readable medium or from another device. The software instructions contained in memory 430 may cause processor 420 to perform processes described herein. Alternatively, hardwired circuitry may be used in place of, or in combination with, software instructions to implement processes described herein. Thus, implementations described herein are not limited to any specific combination of hardware circuitry and software.

Although FIG. 4 shows exemplary components of device 400, in other implementations, device 400 may include fewer components, different components, additional components, or differently arranged components than depicted in FIG. 4. Additionally, or alternatively, one or more components of device 400 may perform one or more tasks described as being performed by one or more other components of device 400.

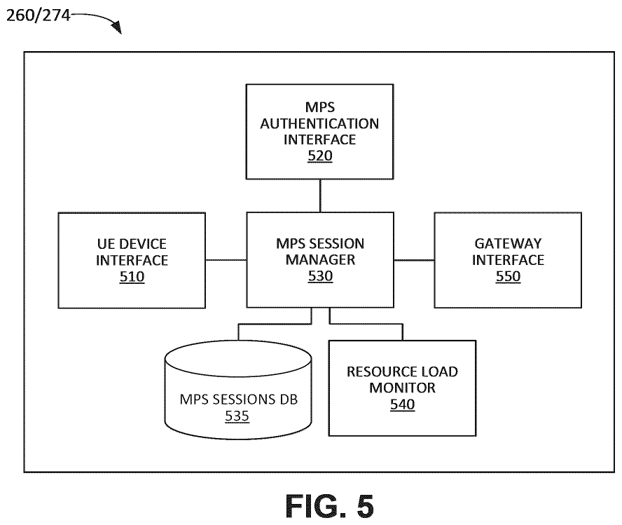

FIG. 5 illustrates exemplary components of ePDG 260 or N3IWF 374. The components of ePDG 260 or N3IWF 374 may be implemented, for example, via processor 420 executing instructions from memory 430. For example, one or more components of ePDG 260 or N3IWF 374 may correspond to the structure of processor 420 together with instructions in memory 430 for implementing the functionality of the component. Alternatively, some or all of the components of ePDG 260 or N3IWF 374 may be implemented via hard-wired circuitry. For example, one or more components of ePDG 260 or N3IWF 374 may correspond to the structure of some or all of an ASIC, FPGA, and/or another type of integrated circuit. As shown in FIG. 5, ePDG 260 or N3IWF 374 may include a UE device interface 510, an MPS authentication interface 520, an MPS session manager 530, an MPS sessions database (DB) 535, a resource load monitor 440, and a gateway interface 550.

UE device interface 510 may be configured to communicate with UE device 110 via WI-FI AP 115. For example, UE device interface 510 may receive a request to establish an MPS session from UE device 110 via WI-FI AP 115. Additionally, UE device interface 510 may set up an IPSec tunnel with UE device 115 via WI-FI AP 115 for an MPS session.

MPS authentication interface 520 may be configured to communicate with an authentication device to authorize UE device 110 for an MPS session. For example, in a 4G core network 150, MPS authentication interface 520 may communicate with HSS 250 via AAA 265 to determine whether UE device 110 is authorized for MPS and for setting up an MPS session. In a 5G core network 150, MPS authentication interface 520 may communicate with UDM 352 to determine whether UE device 110 is authorized for MPS and for setting up an MPS session.

MPS session manager 530 may manage MPS sessions associated with ePDG 260 or N3IWF 374. For example, MPS session manager 530 may receive a request from UE device 110 to start an MPS session and use MPS authentication interface 520 to authenticate the MPS session request. If the MPS session request is authenticated and authorization to start the MPS session is received, MPS session manager 530 may use resource load monitor 540 to determine whether a resource load threshold has been reached. If no resource load thresholds have been reached, MPS session manager 530 may use an existing IPSec tunnel to UE device 110, or create an IPSec tunnel to UE device 110, and assign an MPS priority to data units associated with the MPS session in the IPSec tunnel. Furthermore, MPS session manager 530 may use an existing GTPv2 tunnel, or create a GTPv2 tunnel, to a gateway device (e.g., PGW 240, UPF 330, etc.) to PDN 160 identified in the received MPS request as the destination for the MPS session. MPS session manager 530 may map an MPS priority to data units associated with the MPS session sent via the GTPv2 tunnel.

If at least one resource load threshold has been reached, MPS session manager 530 may generate a dedicated IPSec tunnel to UE device 110 and reserve resources for the generated IPSec tunnel. Furthermore, MPS session manager 530 may generate a dedicated GTPv2 tunnel to the gateway device and reserve resources for the generated GTPv2 tunnel. The reserved resources may include bandwidth resources, port resources, processor time resources, memory resources, and/or other resources necessary to process data units associated with MPS priority for a session type associated with the MPS session. For example, MPS session manager 530 may reserve more resources for a real-time video MPS session than for a voice MPS session.

In some implementations, WI-FI AP 115 may be configured to prioritize UE devices 110 based on an MPS priority. MPS session manager 530 may send an instruction to WI-FI AP 115 to assign an MPS priority to UE device 110. In response, WI-FI AP 115 may enhance the connection to UE device 110 based on the active MPS session.

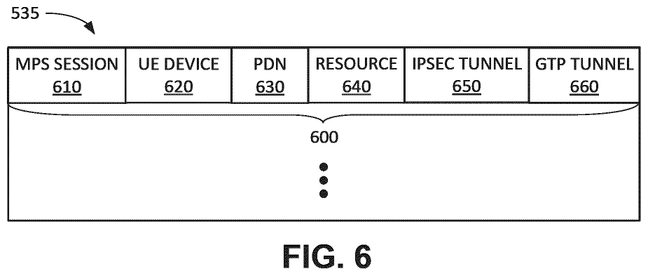

MPS session manager 530 may store information relating to the MPS session in MPS sessions DB 535. MPS sessions DB 535 may store information relating to MPS sessions managed by ePDG 260 or N3IWF 374. Exemplary information that may be stored in MPS sessions DB 535 is described below with reference to FIG. 6.

Resource load monitor 540 may monitor one or more resource parameters associated with ePDG 260 or N3IWF 374 and determine whether one or more resource parameter load threshold have been reached. If at least one resource parameter load is reached, resource load monitor 540 may detect a congestion condition and inform MPS session manager 530 that the congestion condition has been detected. The monitored resource parameters may include, for example, a total number of UE device 110 sessions, a number of UE device 110 sessions of a particular type, a total traffic load, a traffic load for one or more GTP tunnels, a traffic load for one or more IPSec tunnels, a processor load, a memory load, a port load, and/or another type of load associated with ePDG 260 or N3IWF 374. Traffic load may be measured as average downlink and/or uplink throughput, maximum downlink and/or uplink throughput, and/or another type of throughput.

Gateway interface 550 may be configured to communicate with a gateway device to PDN 160, such as PGW 240 or UPF 330. Gateway interface 550 may create, manage and/or delete GTPv2 tunnels to the gateway device and manage data units sent via the GTPv2 tunnel based on an assigned priority, such as an MPS priority.

Although FIG. 5 shows exemplary components of ePDG 260 or N3IWF 374, in other implementations, ePDG 260 or N3IWF 374 may include fewer components, different components, additional components, or differently arranged components than depicted in FIG. 5. Additionally, or alternatively, one or more components of ePDG 260 or N3IWF 374 may perform one or more tasks described as being performed by one or more other components of ePDG 260 or N3IWF 374.

FIG. 6 illustrates exemplary components of MPS sessions DB 535. As shown in FIG. 6, MPS sessions DB 535 may include one or more MPS session records 600. Each MPS session record 600 may include information relating to an MPS session managed by ePDG 260 or N3IWF 374. MPS session record 600 may include an MPS session field 610, a UE device field 620, a PDN field 630, a resource field 640, an IPSec tunnel field 650, and a GTP tunnel field 660.

MPS session field 610 may store information identifying an MPS session, such as an MPS session identifier (ID). UE device field 620 may store information identifying UE device 110 associated with the MPS session. For example, UE device field 620 may store a Mobile Directory Number (MDN), an International Mobile Subscriber Identity (IMSI), a Mobile Station International Subscriber Directory Number (MSISDN), an International Mobile Equipment Identity (IMEI), an ID associated with the subscription for UE device 110 (e.g., a subscription ID, an account number, etc.), and/or another type of ID for UE device 110.

PDN field 630 may store information identifying PDN 160 associated with the MPS session, such as, for example, an APN or DNN for PDN 160. Furthermore, PDN field 630 may store information identifying a gateway device to PDN 160 associated with the MPS session, such as information identifying PGW 240 or UPF 330.

Resource field 640 may store information relating to a resource load for ePDG 260 or N3IWF 374. For example, resource field 640 may store information indicating whether at least one resource load threshold has been reached or a resource parameter associated with ePDG 260 or N3IWF 374 and whether, as a result of the resource load threshold being reached, resources for a dedicated IPSec tunnel and/or a dedicated GTP tunnel have been reserved. If resources have been reserved, resource field 640 may store information identifying the type of resource and/or the amount of resources that have been reserved. The reserved resources may include processor, memory, port, and/or other types of device and/or network resources associated with ePDG 260 or N3IWF 374.

IPSec tunnel field 650 may store information identifying an IPSec tunnel associated with the MPS session, whether the IPSec tunnel is dedicated for the MPS session, and/or one or more parameters associated with the IPSec tunnel (e.g., encryption type, hashing type, authentication type, etc.). GTP tunnel field 660 may store information identifying a GTPv2tunnel associated with the MPS session, whether the GTP tunnel is dedicated for the MPS session, and/or one or more parameters associated with the GTP tunnel (e.g., tunnel endpoint IDs, etc.).

Although FIG. 6 shows exemplary components of MPS sessions DB 535, in other implementations, MPS sessions DB 535 may include fewer components, different components, additional components, or differently arranged components than depicted in FIG. 6.

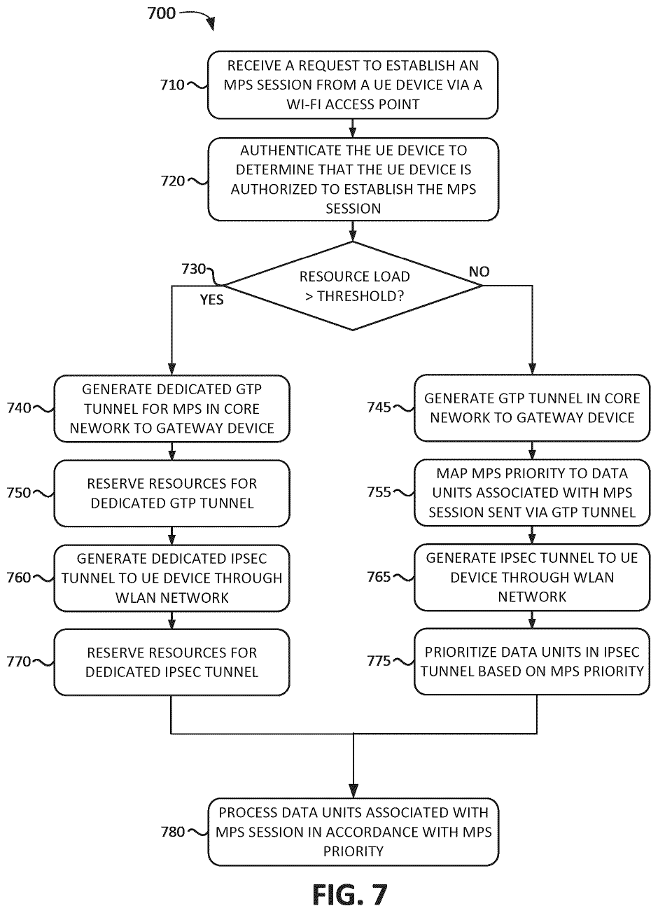

FIG. 7 illustrates a flowchart of a process 700 for establishing and managing an MPS session. In some implementations, process 700 of FIG. 7 may be performed by ePDG 260 or N3IWF 374. In other implementations, some or all of process 700 may be performed by another device or a group of devices separate from ePDG 260 or N3IWF 374.

As shown in FIG. 7, process 700 may include receiving a request to establish an MPS session from a UE device via a WI-FI access point (block 710). For example, ePDG 260 or N3IWF 374 may receive a request to establish an MPS session from UE device 110 via WI-FI AP 115. Process 700 may further include authenticating the UE device to determine that the UE device is authorized to establish the MPS session (block 720). For example, in a 4G core network 150, ePDG 260 may communicate with HSS 250 via AAA 265 to determine whether UE device 110 is authorized for MPS and for setting up an MPS session. In a 5G core network 150, N3IWF 374 may communicate with UDM 352 to determine whether UE device 110 is authorized for MPS and for setting up an MPS session.

A determination may be made as to whether a resource load is greater than a threshold (block 730). For example, ePDG 260 or N3IWF 374 may check values for one or more resource parameters and compare the values to one or more corresponding resource parameter thresholds. The resource parameters may include, for example, a total number of UE device 110 sessions, a number of UE device 110 sessions of a particular type, a total traffic load, a traffic load for one or more GTP tunnels, a traffic load for one or more IPSec tunnels, a processor load, a memory load, a port load, and/or another type of load associated with ePDG 260 or N3IWF 374.

If it is determined that the resource load is greater than the threshold (block 730-YES), process 700 may include generating a dedicated GTP tunnel for MPS in a core network to a gateway device (block 740), reserving resources for the dedicated GTP tunnel (block 750), generating a dedicated IPSec tunnel to a UE device through a WLAN network (block 760), and reserving resources for the dedicated IPSec tunnel (block 770). For example, ePDG 260 or N3IWF 374 may use an existing IPSec tunnel to UE device 110, or create an IPSec tunnel to UE device 110, and assign an MPS priority to data units associated with the MPS session in the IPSec tunnel. Furthermore, ePDG 260 or N3IWF 374 may use an existing GTPv2 tunnel, or create a GTPv2 tunnel, to a gateway device (e.g., PGW 240, UPF 330, etc.) to PDN 160 identified in the received MPS request as the destination for the MPS session. ePDG 260 or N3IWF 374 may map an MPS priority to data units, associated with the MPS session, to be sent via the GTPv2 tunnel or received via the GPv2 tunnel.

If it is determined that the resource load is not greater than the threshold (block 730-NO), process 700 may include generating a GTP tunnel in a core network to a gateway device (block 745), mapping MPS priority to data units associated with the MPS session and sent via the GTP tunnel (block 755), generating an IPSec tunnel to a UE device through a WLAN network (block 765), and prioritizing data units associated with the MPS session in the IPSec tunnel based on an MPS priority (block 775). For example, ePDG 260 or N3IWF 374 may generate a dedicated IPSec tunnel to UE device 110 and reserve resources for the generated IPSec tunnel. Furthermore, MPS session manager 530 may generate a dedicated GTPv2 tunnel to the gateway device and reserve resources for the generated GTPv2 tunnel. The reserved resources may include bandwidth resources, port resources, processor time resources, memory resources, and/or other resources necessary to process data units associated with MPS session.

In some implementations, WI-FI AP 115 may be configured to prioritize UE devices 110 based on an MPS priority. ePDG 260 or N3IWF 374 may send an instruction to WI-FI AP 115 to assign an MPS priority to UE device 110 and to give UE device 110 priority over other non-MPS UE devices 110. In response, WI-FI AP 115 may prioritize the connection to UE device 110 based on the MPS priority while the MPS session is active.

Process 700 may further include processing data units associated with the MPS session in accordance with MPS priority (block 780). For example, ePDG 260 or N3IWF 374 may receive data units associated with the MPS session from UE device 110 via WI-FI AP 115 using the IPSec tunnel and forward the received data units to PGW 240 or UPF 330 via the GTPv2 tunnel. Furthermore, ePDG 260 or N3IWF 374 may receive data units associated with the MPS session from PGW 240 or UPF 330 via the GTPv2 tunnel and forward the received data units to UE device 110 via WI-FI AP 115 using the IPSec tunnel. ePDG 260 or N3IWF 374 may give higher access to the data units associated with the MPS session.

In some implementations, process 700 may include monitoring for resource loads even after the MPS session has been established. For example, if, after the MPS session has been established, ePDG 260 or N3IWF 374 detects that a resource load for a resource parameter has become greater than the resource load threshold, ePDG 260 or N3IWF 374 may generate a dedicated GTPv2 tunnel for the MPS session, reserve resources for the dedicated GTPv2 tunnel, generate a dedicated IPSec tunnel for the MPS session, reserve resources for the dedicated IPSec tunnel, and transfer the MPS session to the generated dedicated GTPv2 and IPSec tunnels.

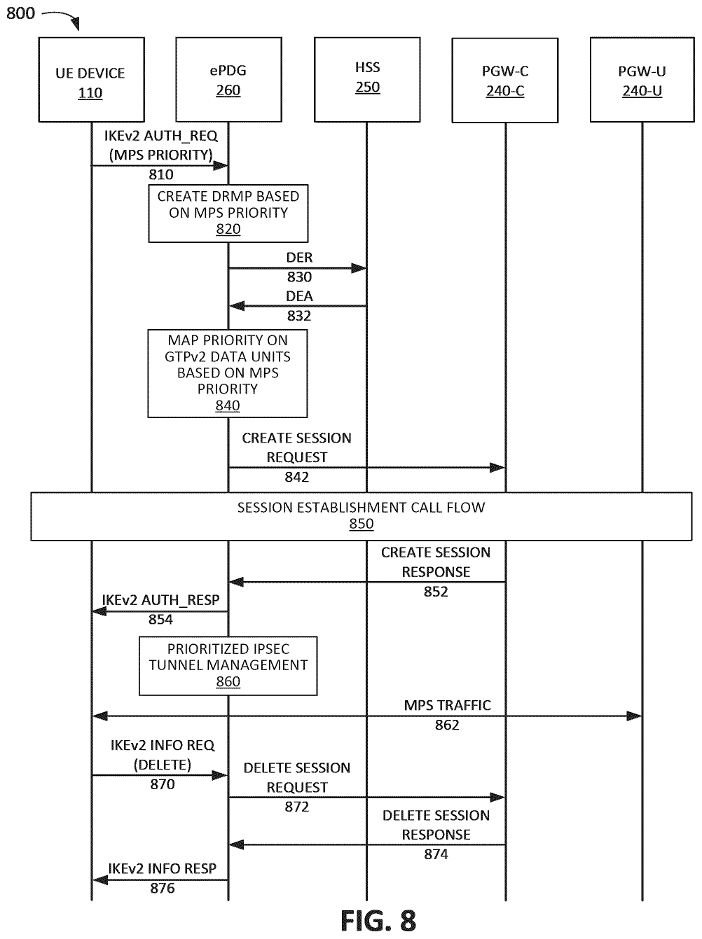

FIG. 8 illustrates a first exemplary signal flow diagram 800. Signal flow 800 illustrates MPS management in a 4G core network 150. As shown in FIG. 8, signal flow 800 may include UE device 110 sending an Internet Key Exchange version 2 (IKEv2) request to set up an IPSec tunnel to ePDG 260 via WI-FI AP 115 (not shown in FIG. 8) for an IPSec tunnel with MPS priority (block 810). The request for an IPSec tunnel with MPS priority may be generated by an MPS application or service installed on UE device 110 and/or included on a Subscriber Identity Module (SIM) included or embedded in UE device 110.

ePDG 260 may receive the request and create a Diameter Routing Message Priority (DRMP) based on the MPS priority (block 820) and send a Diameter Extensible Authentication Protocol (EAP) Request (DER) to HSS 250 via AAA 265 (not shown in FIG. 8) with the created DRMP (signal 830). HSS 250 may respond to ePDG 260 via AAA 265 with a Diameter EAP Answer (DEA) authorizing the DRMP for UE device (signal 832). ePDG 260 may then map the MPS priority to data units associated with the MPS session on a GTPv2 tunnel to be used for the MPS session (block 840) and send a create session request to a PGW Control Plane (PGW-C) 240-C. A session establishment call flow may then be performed to create the MPS session between UE device 110 and PGW User Plane (PGW-U) 240-U via ePDG 260 (block 850).

At the completion of the session establishment call flow, PGW-C 240-C may send a create session response to ePDG 260 indicating the MPS session has been created (signal 852). ePDG 260 may then complete the creation of the IPSec tunnel by sending an IKEv2authorization response to UE device 110 via WI-FI AP 115 (signal 854). ePDG 260 may perform prioritized IPSec tunnel management on data units associated with the MPS session (block 860) and MPS traffic for the MPS session may flow between UE device 110 via WI-FI AP 115 to ePDG 260 and between ePDG 260 and PGW-U 240-U (signal 862).

At the end of the MPS session, UE device 110 may send an IKEv2 information request with a delete request to ePDG 260 (signal 870). ePDG 260 may then send a delete session request to PGW-C 240-C to delete the MPS session on the GTPv2 tunnel to PGW-C 240-C (signal 872). PGW-C 240-C may respond with a delete session response (signal 874) to ePDG 260 and ePDG 260 may send an IKEv2 information response to UE device 110 indicating that termination of the MSP session is complete (signal 876).

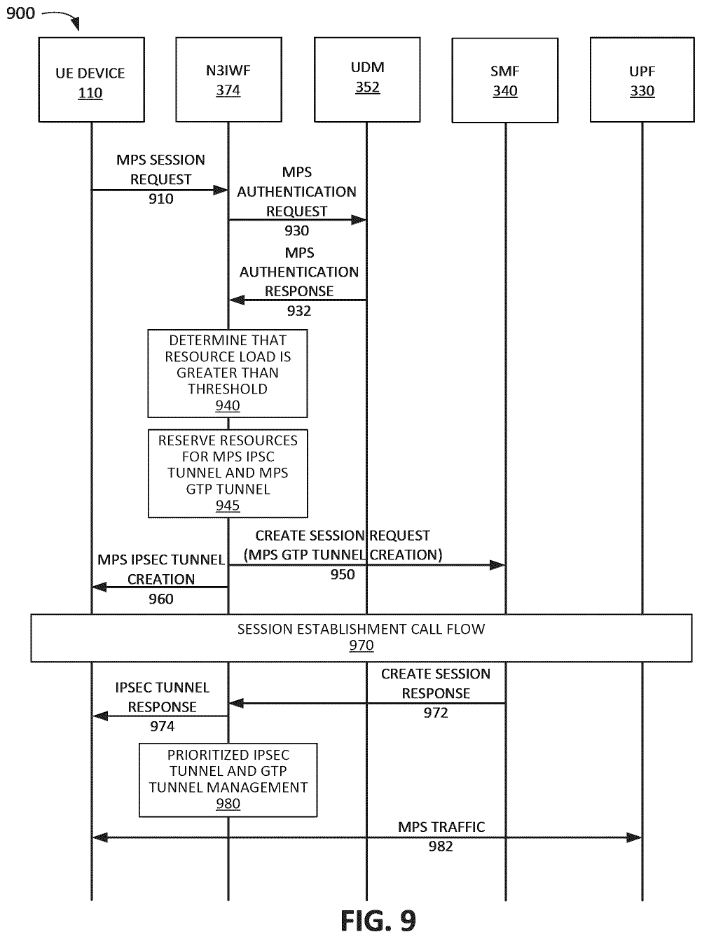

FIG. 9 illustrates a second exemplary signal flow diagram 900. Signal flow 900 illustrates MPS management in a 5G core network 150. As shown in FIG. 9, signal flow 900 may include UE device 110 sending an MPS session request to N3IWF 374 via WI-FI AP 115 (not shown in FIG. 9) for an IPSec tunnel with MPS priority (block 910). The request for the MPS session may be generated by an MPS application or service installed on UE device 110 and/or included on a SIM included or embedded in UE device 110. N3IWF 374 may receive the request and send an MPS authentication request to UDM 352 to authorize the requested MPS session for UE device 110 (signal 930) and UDM 352 may respond with an MPS authentication response (signal 932).

N3IWF 374 may analyze its resource load and determine that a resource load is greater than a threshold (block 940). For example, N3IWF 374 may determine that a current traffic load exceeds a traffic load threshold. In response, N3IWF 374 may reserve resources for a dedicated MPS IPSec tunnel and/or a dedicated MPS GTPv2 tunnel (block 945). N3IWF 374 may then send a create session request to SMF 340 to create a Protocol Data Unit (PDU) session with an MPS priority. Furthermore, N3IWF 374 may then create a dedicated IPSec tunnel to UE device 110 for the MPS session (block 960). A session establishment call flow may then be performed to create the MPS session between UE device 110 and UPF 330 via N3IWF 374 (block 970).

At the completion of the session establishment call flow, SMF 340 may send a create session response to N3IWF 374 indicating the MPS session has been created (signal 972). N3IWF 374 may then complete the creation of the IPSec tunnel by sending an IPSec tunnel response to UE device 110 via WI-FI AP 115 (signal 974). N3IWF 374 may perform prioritized IPSec and/or GTP tunnel management on data units associated with the MPS session (block 980) and MPS traffic for the MPS session may flow between UE device 110 via WI-FI AP 115 to N3IWF 374 and between N3IWF 374 and UPF 330 (signal 962).

In the preceding specification, various preferred embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

For example, while a series of blocks have been described with respect to FIG. 7, and a series of signals have been described with respect to FIGS. 8 and 9, the order of the blocks, and/or signals, may be modified in other implementations. Further, non-dependent blocks and/or signals may be performed in parallel.

It will be apparent that systems and/or methods, as described above, may be implemented in many different forms of software, firmware, and hardware in the implementations illustrated in the figures. The actual software code or specialized control hardware used to implement these systems and methods is not limiting of the embodiments. Thus, the operation and behavior of the systems and methods were described without reference to the specific software code—it being understood that software and control hardware can be designed to implement the systems and methods based on the description herein.

Further, certain portions, described above, may be implemented as a component that performs one or more functions. A component, as used herein, may include hardware, such as a processor, an ASIC, or a FPGA, or a combination of hardware and software (e.g., a processor executing software).

It should be emphasized that the terms “comprises”/“comprising” when used in this specification are taken to specify the presence of stated features, integers, steps or components but does not preclude the presence or addition of one or more other features, integers, steps, components or groups thereof.

The term “logic,” as used herein, may refer to a combination of one or more processors configured to execute instructions stored in one or more memory devices, may refer to hardwired circuitry, and/or may refer to a combination thereof. Furthermore, a logic may be included in a single device or may be distributed across multiple, and possibly remote, devices.

For the purposes of describing and defining the present invention, it is additionally noted that the term “substantially” is utilized herein to represent the inherent degree of uncertainty that may be attributed to any quantitative comparison, value, measurement, or other representation. The term “substantially” is also utilized herein to represent the degree by which a quantitative representation may vary from a stated reference without resulting in a change in the basic function of the subject matter at issue.

To the extent the aforementioned embodiments collect, store, or employ personal information of individuals, it should be understood that such information shall be collected, stored, and used in accordance with all applicable laws concerning protection of personal information. Additionally, the collection, storage and use of such information may be subject to consent of the individual to such activity, for example, through well known “opt-in” or “opt-out” processes as may be appropriate for the situation and type of information. Storage and use of personal information may be in an appropriately secure manner reflective of the type of information, for example, through various encryption and anonymization techniques for particularly sensitive information.

No element, act, or instruction used in the present application should be construed as critical or essential to the embodiments unless explicitly described as such. Also, as used herein, the article “a” is intended to include one or more items. Further, the phrase “based on” is intended to mean “based, at least in part, on” unless explicitly stated otherwise.

What is claimed is:

1. A method comprising:
receiving, by a device, a request to establish a Multimedia Priority Service (MPS) session for a user equipment (UE) device;
generating, by the device, a General Packet Radio Service (GPRS) Tunnelling Protocol (GTP) tunnel in a core network from the device to a gateway associated with a packet data network (PDN);
mapping, by the device, an MPS priority to data units associated with the MPS session sent via the generated GTP tunnel;
generating, by the device, an Internet Protocol Security (IPSec) tunnel from the device to the UE device through a wireless local area network (WLAN); and
prioritizing, by the device, data units associated with the MPS session through the IPSec tunnel based on the MPS priority.

2. The method of claim 1, further comprising:
authenticating the UE device to determine that the UE device is authorized to establish the MPS session.

3. The method of claim 1, further comprising:
determining that a load for a resource parameter associated with the device is greater than a resource load threshold;
generating a dedicated IPSec tunnel for MPS data units to the UE device, in response to determining that the load for the resource parameter associated with the device is greater than the resource load threshold; and
using the generated dedicated IPSec tunnel to the UE device for the MPS data units for the UE device.

4. The method of claim 3, further comprising:
generating a dedicated GTP tunnel to the gateway for the MPS data units, in response to determining that the load for the resource parameter associated with the device is greater than the resource load threshold; and
using the generated dedicated GTP tunnel to the gateway for the MPS data units for the UE device.

5. The method of claim 3, further comprising:
reserving resources associated with the resource parameter for the dedicated IPSec tunnel for the MPS data units to the UE device.

6. The method of claim 3, wherein the resource parameter includes at least one of:
a number of UE device connections associated with the device;
a traffic load for one or more GTP tunnels associated with the device;
a traffic load for one or more IPSec tunnels associated with the device;
a processor load associated with the device;
a memory load associated with the device; or
a port load associated with the device.

7. The method of claim 1, wherein the device includes an evolved Packet Data Gateway (ePDG).

8. The method of claim 1, wherein the device includes a Non-Third-Generation-Partnership-Project Interworking Function (N3IWF).

9. The method of claim 1, further comprising:
instructing a WI-FI Access Point (AP) device associated with the MPS session for the UE device to process data units associated with the MPS session based on the MPS priority.

10. A device comprising:
a processor configured to:
receive a request to establish a Multimedia Priority Service (MPS) session for a user equipment (UE) device;
generate a General Packet Radio Service (GPRS) Tunnelling Protocol (GTP) tunnel in a core network from the device to a gateway associated with a packet data network (PDN);
map an MPS priority to data units associated with the MPS session sent via the generated GTP tunnel;
generate an Internet Protocol Security (IPSec) tunnel from the device to the UE device through a wireless local area network (WLAN); and
prioritize data units associated with the MPS session through the IPSec tunnel based on the MPS priority.

11. The device of claim 10, wherein the processor is further configured to:
authenticate the UE device to determine that the UE device is authorized to establish the MPS session.

12. The device of claim 10, wherein the processor is further configured to:
determine that a load for a resource parameter associated with the device is greater than a resource load threshold;
generate a dedicated IPSec tunnel for MPS data units to the UE device, in response to determining that the load for the resource parameter associated with the device is greater than the resource load threshold; and
use the generated dedicated IPSec tunnel to the UE device for the MPS data units for the UE device.

13. The device of claim 12, wherein the processor is further configured to:
generate a dedicated GTP tunnel to the gateway for the MPS data units, in response to determining that the load for the resource parameter associated with the device is greater than the resource load threshold; and
use the generated dedicated GTP tunnel to the gateway for the MPS data units for the UE device.

14. The device of claim 12, wherein the processor is further configured to:
reserve resources associated with the resource parameter for the dedicated IPSec tunnel for the MPS data units to the UE device.

15. The device of claim 14, wherein the resource parameter includes at least one of:
a number of UE device connections associated with the device;
a traffic load for one or more GTP tunnels associated with the device;
a traffic load for one or more IPSec tunnels associated with the device;
a processor load associated with the device;
a memory load associated with the device; or
a port load associated with the device.

16. The device of claim 10, wherein the device includes an evolved Packet Data Gateway (ePDG).

17. The device of claim 10, wherein the device includes a Non-Third-Generation-Partnership-Project Interworking Function (N3IWF).

18. The device of claim 10, wherein the processor is further configured to:
instruct a WI-FI Access Point (AP) device associated with the MPS session for the UE device to process data units associated with the MPS session based on the MPS priority.

19. A non-transitory computer-readable memory device storing instructions executable by a processor, the non-transitory computer-readable memory device comprising:
one or more instructions to receive a request to establish a Multimedia Priority Service (MPS) session for a user equipment (UE) device;
one or more instructions to generate a General Packet Radio Service (GPRS) Tunnelling Protocol (GTP) tunnel in a core network from the device to a gateway associated with a packet data network (PDN);
one or more instructions to map an MPS priority to data units associated with the MPS session sent via the generated GTP tunnel;
one or more instructions to generate an Internet Protocol Security (IPSec) tunnel from the device to the UE device through a wireless local area network (WLAN); and
one or more instructions to prioritize data units associated with the MPS session through the IPSec tunnel based on the MPS priority.

20. The non-transitory computer-readable memory device of claim 19, further comprising:
one or more instructions to determine that a load for a resource parameter associated with the device is greater than a resource load threshold;
one or more instructions to generate a dedicated IPSec tunnel for MPS data units to the UE device, in response to determining that the load for the resource parameter associated with the device is greater than the resource load threshold; and
one or more instructions to use the generated dedicated IPSec tunnel to the UE device for MPS data units associated with MPS session for the UE device.
